(19) United States
(12) Patent Application Publication
(10) Pub. No.: US 2026/0286249 A1
(43) Pub. Date: Sep. 24, 2026

(54) POLYALKOXYLATED COMPOUNDS, THEIR PREPARATION AND THEIR USE

(71) Applicant: SPECIALTY OPERATIONS FRANCE, Lyon (FR)

(72) Inventor: Estelle Lescoat, Rueil-Malmaison (FR)

(73) Assignee: SPECIALTY OPERATIONS FRANCE, Lyon (FR)

(21) Appl. No.: 19/472,492

(22) PCT Filed: Apr. 3, 2024
(86) PCT No.: PCT/EP2024/059065

§ 371 Date: Oct. 3, 2025

(30) Foreign Application Priority Data
Apr. 5, 2023 (EP) 23166871.6

(51) Int. Cl. C11D 1/722; C08G 65/26

(52) U.S. Cl. CPC C11D 1/722; C08G 65/2612; C11D 2111/16; C11D 2111/20; C11D 2111/24

(57) ABSTRACT

The present invention relates to polyalkoxylated compounds, their process of preparation and their use as surfactants and defoaming agents.

This application is a national stage entry of International Application No. PCT/EP2024/059065 filed on Apr. 3, 2024, which claims priority to European Application No. 23166871.6 filed on Apr. 5, 2023. The entire contents of each of these applications are incorporated herein by reference for all purposes.

### BACKGROUND OF THE INVENTION

The present invention relates to polyalkoxylated compounds, their process of preparation and their use as surfactants and defoaming agents.

Polyalkoxylated terpenic derivatives which exhibit outstanding properties of defoaming aqueous media are disclosed in U.S. Pat. No. 6,846,798.

The known polyalkoxylated terpenic compounds are derived from terpene which itself is derived from pine oil. Thus, the known compounds can be prepared from natural sources. However, the main end use of terpene is in the fragrance industry, which decreases its availability and increases its price.

Therefore, it is desirable to provide an alternative compound which has defoaming properties being similar to or even better as the defoaming properties of the known polyalkoxylated terpenic compounds. Furthermore, it is desirable to provide such compounds which are at least partly biosourced, in particular which can be obtained from a starting compound which is cheaper than terpene. Additionally, it is desirable to provide such compound which is biodegradable.

### BRIEF SUMMARY OF THE INVENTION

It has surprisingly been found that the above problems can be solved by a compound which is obtainable by alkoxylation of the reaction product of a ketone, and a polyol. Such alkoxylated compounds exhibit excellent defoaming and surfactant properties and are easily biodegradable. In a preferred embodiment, the reaction product of the ketone and the polyol is [2-methyl-2-(methylpropyl)-1,3-dioxolane-4-yl]methanol, which can be obtained by reacting methyl isobutyl ketone (MIBK) with glycerol.

U.S. Pat. No. 5,744,065 relates to nonionic splittable surfactants and their use in industrial, commercial and institutional applications. It discloses a process for the preparation of acetals via the condensation of aldehydes with polyols (glycerol) and a process for the alkoxylation of acetals to produce acetal-derived surfactants.

The Applicant has found that when starting from a ketone instead of an aldehyde, the resulting acetal and hence also the final alkoxylated product is more hydrophobic which theoretically shows better cleaning performances, especially when the alkoxylation used besides ethylene oxide (EO), a higher alkoxide like propylene oxide (PO) or butylene oxide (BO).

The invention furthermore relates to a process for the production of the above compounds, their use as surfactant and/or defoaming agent, and aqueous compositions comprising these compounds.

### DETAILED DESCRIPTION

The present invention relates to a compound obtainable by alkoxylation of the reaction product of a ketone, and a polyol.

Suitable polyols are organic compounds comprising an uneven number of hydroxy groups, preferably at least three hydroxy groups such that two of the hydroxy groups can react with the ketone while the third hydroxy group remains intact and may then react for example with epoxides to form the desired alkoxylated compounds. Suitable reaction conditions are well known to a person skilled in the art.

The alkoxylation of the reaction product of the ketone and the polyol alkoxylation is preferably conducted using two or more epoxide(s), preferably two epoxide(s), more preferably ethylene oxide and propylene oxide, or ethylene oxide and butylene oxide, and most preferably ethylene oxide and propylene oxide.

Suitable polyols for the preparation of the reaction product of the ketone and the polyol are sugars and glycerol, the latter being preferred.

Suitable sugars include glucofuranose, allofuranose, fructopyranose, mannofuranose and galactopyranose.

Suitable ketones for the reaction include, acetone, MIBK, acetophenone, cyclopentanone, cyclohexanone etc., cyclopentanone, cyclohexanone and MIBK being preferred, MIBK being particularly preferred.

Examples of corresponding reaction products are:

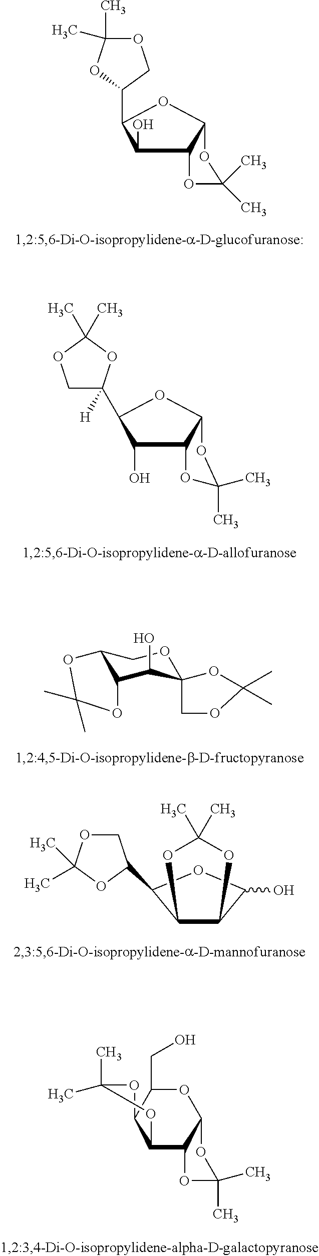

In the case of MIBK, cyclopentanone or cyclyhexanone respectively+glycerol, the reactions are as follows:

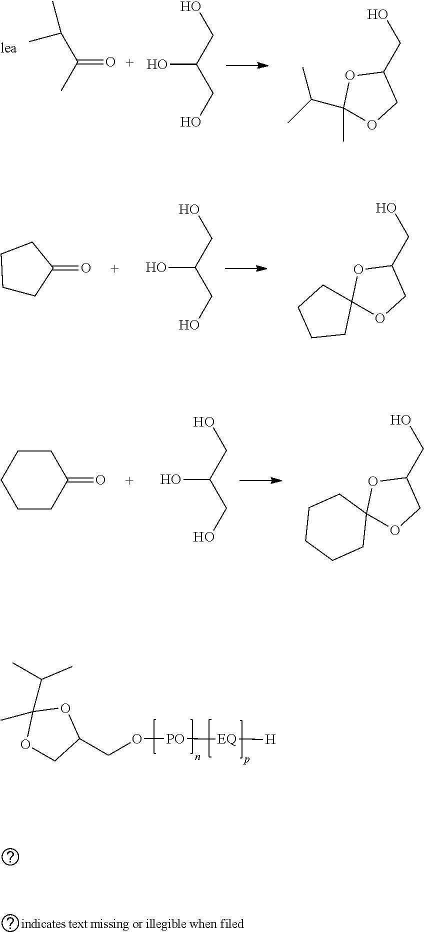

It is namely so that preferred reaction products according to the invention have the general formula Z—(XO)n-(EO)p-(XO)q-H, wherein:
Z is the radical deriving from the reaction product of the ketone with the polyol, preferably from the reaction product of MIBK with glycerol;
XO is PO and/or BO (meaning it might be a mixture of both, but it preferably is either PO or BO);
n is a mean value which can range from 1 to 12, preferably from 5 to 9, more preferably from 7 to 9;
p is a mean value which can range from 1 to 12, preferably from 5 to 9, more preferably from 5 to 7; and
q is a mean value which can range from 0 to 12, preferably from 0 to 4; in practice, good results are obtained when q is equal to 0.

In a first preferred embodiment, q is 0 and in that case, the reaction product is preferably either Z—(XO)n-bloc-(EO)p-H or Z—(XO)n-stat-(EO)p-H, wherein Z is preferably the radical deriving from the reaction product of MIBK with glycerol.

In a second embodiment, q is not 0 and in that case, the reaction product is preferably either Z—(XO)n-bloc-(EO)p-bloc-(XO)q-H or Z—(XO)n-bloc-[(EO)p-stat-(XO)q]-H or Z—[(XO)n-stat-(EO)p]-bloc-(XO)q-H, wherein Z is preferably the radical deriving from the reaction product of MIBK with glycerol.

The embodiment according to which the reaction product is Z—(XO)n-bloc-(EO)p-H gives good results in practice, especially when XO is PO and more particularly when Z is the radical deriving from the reaction product of MIBK with glycerol.

Therefore, the subject matter of the present invention is more particularly a compound of formula (I)

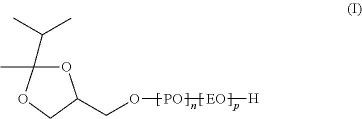

wherein the [PO]n symbol represents a polyoxypropylene block,
the [EO]p symbol represents a poyloxyethylene block,
n being a mean value which can range from 1 to 12, preferably from 5 to 9, more preferably from 7 to 9; and
p being a mean value which can range from 1 to 12, preferably from 5 to 9, more preferably from 5 to 7.

In a preferred embodiment, the ratio n/p is superior to 1, preferably comprised between 1.0 and 2.0, more preferably between 1.1 and 1.9, even more preferably between 1.1 and 1.5.

The mean values of n and p are preferably chosen so that a 1% by weight solution in distilled water of the said compound exhibits a cloud point of less than 40° C.

In a preferred embodiment, the process comprises the step of successively carrying out polyalkoxylation reactions with a reactant of formula (II)

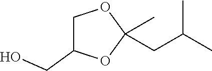

with polyethylene oxide in order to obtain the polyalkoxylated compound.

The compound of formula (II) can be obtained by reacting methyl isobutyl ketone (MIBK) with glycerol. One such method is described in example 1 of U.S. Pat. No. 2,690,444, the content of which is incorporated herein by reference.

The polyalkoxylation reactions are carried out according to well-known methods at a temperature greater than 100° C., preferably between 12° and 250° C., very particularly between 150 and 200° C., in the presence of a catalyst (strong bases, aliphatic amines, Lewis acids). The operation is advantageously carried out in the presence of an inert gas (nitrogen) or of a rare gas (argon or carbon monoxide), preferably at a pressure of the order of 1 to 4 bar. This type of reaction is given in greater detail in International Application WO 96/01245.

The propylene oxide (PO) and the ethylene oxide (EO) are introduced successively. The amounts of propylene or ethylene oxide employed correspond to the numbers of molar equivalents n and p desired. The conditions for carrying out such a procedure are well known to a person skilled in the art.

Another subject-matter of the present invention is the use of at least one compound as defined above as surfactant or defoaming agent, in aqueous media capable of forming foams. Such aqueous media are for instance aqueous media for degreasing metal parts (metal sheets, metal coils . . . ), aqueous media for degreasing drilling platforms, aqueous media employed for cleaning oil drilling wells and aqueous detergent media use in household detergency or in industrial and institutional detergency. In a specific embodiment, the compound as described above is used as surfactant for hard surface cleaning, e.g. metal cleaning, or as metal working fluid (MWF).

The aqueous media, for which it is necessary to limit the volume of foam which can be formed during their use, are in particular aqueous media for degreasing metal sheets in alkaline medium, aqueous media for degreasing drilling platforms, aqueous media employed for cleaning oil drilling wells drilled by means of oil-based fluids, and aqueous detergent media used in household detergency (washing machines, dishwashers, washing of hard surfaces) or in industrial and institutional detergency.

During the use of aqueous media for degreasing metal sheets in alkaline medium, the formation of foam can result from the presence in the degreasing composition of foaming detergent surface-active agents, as well as the presence of soaps resulting from fatty acids or from esters present in the contaminating medium to be removed.

These same difficulties can appear during the degreasing of oil platforms. It should be noted that, in the field of oil exploitation, the foaming can also be caused by the presence of foaming compounds in the crude oil. The phenomenon of foaming is very often dangerous in this specific application. Thus, in addition to the obvious problems of safety present on platforms which have become slippery, the creation of foam in the well itself, during the operation of cleaning the latter before the latter is brought into production, has the consequence of decreasing the relative density in the well (by inclusion of air) and can, for example, result in the uncontrolled eruption of the oil if it is a gusher.

During the use of aqueous detergent media in household detergency or in industrial and institutional detergency, the appearance of foam can be due to the presence, in the detergent composition, of foaming detergent surface-active agents, as well as to the presence of certain residues, such as food proteins of the albumin type, milk, and the like.

The said defoaming agent according to the invention can be employed in the, aqueous medium, for which it is necessary to limit the volume of foam formed, either via degreasing or detergent compositions, by introduction of the said agent into the said compositions at the time of the manufacture of the latter or by introduction of the said agent into the said compositions at the time of use of the latter, or alternatively by direct addition of the said agent to the aqueous medium for which it is necessary to limit the volume of foam formed.

The latter is employed according to amounts which are a function of the amount of foaming agent(s) present in the aqueous medium and of the foaming power of the latter.

In aqueous media for degreasing metal sheets in alkaline medium, the said defoaming agents can be generally present in a proportion of the order of 0.01 to 5 g/l, preferably of the order 0.1 to 5 g/l, of the said medium.

In the field of oil exploitation, more particularly the degreasing of platforms, the aqueous media comprise of the order of 0.005 to 0.05 g/l, preferably of the order of 0.015 to 0.025 g/l, of the said medium (after dilution) of defoaming agents.

For what relates more particularly to the cleaning of the well, the amount of defoaming agent is employed with a concentration of between 0.5 and 10% by weight in the aqueous solution, preferably 1 to 5%.

In the field of washing-machine household detergency, amounts of defoaming agents of the order of 2 to 10%, preferably of the order of 3 to 5%, by weight with respect to the dry content of the detergent medium, for a conventional detergent formulation containing of the order of 5 to 15% of anionic and/or nonionic surface-active agents, are recommended. In dishwasher household detergency, these amounts can be of the order of 0.5 to 10%, preferably in the order of 1 to 3%.

In the aqueous media used in industrial and institutional detergency, the said defoaming agents can be generally present in a proportion of the order of 0.005 to 0.05 g/l, preferably of the order of 0.015 to 0.025 g/l, of the said medium (after dilution).

The degreasing or detergent aqueous media comprising the said defoaming agent of the invention are preferably used at a temperature at least of the order of their cloud temperature. Preferably, the use temperature is at least 20° C. above the cloud temperature. Generally, the use temperature is above 50° C.

Another subject matter of the present invention is an aqueous formulation for degreasing metal surfaces in alkaline medium or oil drilling wells or detergents comprising at least one compound as defined above.

Should the disclosure of any patents, patent applications, and publications which are incorporated herein by reference conflict with the description of the present application to the extent that it may render a term unclear, the present description shall take precedence.

The following examples are given by way of illustration.

### Example 1

8 different alkoxylated 1,3-dioxolane derivatives according to the invention were prepared using a method similar to the method described in example 1 of U.S. Pat. No. 6,846,798, namely according to the following protocol:

4 hydroxymethyl-2-isobutyl-2-methyl-1,3-dioxolan (IUPAC name [2-methyl-2-(methylpropyl)-1,3-dioxolane-4-yl]methanol, compound of formula II, 175 g, 1 mole) and sodium hydroxide 100% (0.8 g, 0.02 moles) are introduced into a alkoxylation reactor.

The reaction mixture is dehydrated between 100° C. and 120° C. under full vacuum to have a water content of less than 500 ppm. Then, the reactor is pressurized with an inert gas (nitrogen) up to 0.5 bar, the mixture is heated between 120° C. and 160° C. and propylene oxide (from 290 to 580 g, from 5 to 10 moles) is introduced, controlling the total pressure of the reactor between 1 and 5 bar. At the end of the addition of propylene oxide, ethylene oxide (from 176 to 396 g, from 4 to 9 moles) is introduced, controlling the total pressure of the reactor between 1 and 5 bar. The reaction mixture is cooled between 40° C. and 80° C. and then neutralized by addition of acetic acid or iso-nonanoic acid until obtaining a pH of 7. A solution in water comprising 1% by weight of the obtained alkoxylated product exhibits a cloud temperature between 25° C. and 50° C.

### Example 2

Biodegradability of the compounds prepared in example 1 was tested. All samples were tested according to OECD 301F. All samples passed the test for biodegradability.

### Example 3

The cloud points of the compounds obtained in example 1 were measured at a concentration of 1% by weight in deionized water. By heating slowly the solutions, they became turbid and the temperature of the bath at that moment (which is by definition the cloud point) is recorded. Two tests are carried out and the average value is listed in Table 1 below.

The cloud point has a relationship with the cleaning performance. It was found that the cleaning performance of formulations comprising the compounds of the present invention was similar to the cleaning performance of formulations comprising prior art compounds as disclosed in U.S. Pat. No. 6,846,798.

TABLE 1

| | Ratio | Cloud point |
|---|---|---|
| | PO/EO | measured (1% by |
| Surfactant | (*) | weight in water |
| #1 | 5/7 | 47 |
| #2 | 5/8 | 47.5 |
| #3 | 5/9 | 48.5 |
| #4 | 6/7 | 39.5 |
| #5 | 7/7 | 35 |
| #6 | 8/7 | 32 |
| #7 | 8/5 | 27 |
| #8 | 9/5 | 25 |

(*) n/p

Increasing the molar ratio PO/EO leads to a decrease of the cloud points of the surfactants.

### Example 4

### Degreasing Test

Gardobond® test panels from Chemetall (MBZE=Electro-galvanized steel and Al 6014 (automotive quality)) were tested according to the following protocol.

Substrates panels (automotive grade) with dimensions of 1×190×105 mm, are immersed in solvent (Isopropanol/heptane: 50:50) for 20 minutes under magnetic stirring at 500 rpm in order to remove traces of oil on the surface. After solvent draining, they are oiled by deposing of anticorrosion oils drops as Ferrocote® 6130 and Anticorit® PL 3802-39S to get a coating weight of 2 g/m2. Then oiled panels were suspended at RT (Room Temperature) then used for cleaning tests or siccativated at 130° C. for 20 min (VDA 230-213) in an oven and tested. The degreasing temperature is 55° C. and the alkaline bath is maintained under magnetic stirring. A degreasing medium (pH 10.5) is prepared by diluting an aqueous detergent containing of 45% by weight of active material and composed of 0.225% by weight of potassium hydroxide, 0.15% by weight of potassium phosphate tribasic, 0.075% by weight of potassium pyrophosphate, 0.15% by weight of potassium carbonate and 0.075% by weight of sodium gluconate in water followed by adding the indicated concentration of tested surfactants. The immersion time of the panels in the degreasing solution is chosen in order to allow for a complete degreasing (grading 4: complete wetting of both faces of the panels by a continuous film of water). After dipping, the panels are rinsed with tap water then DI water at RT for 30 seconds each. The time required to achieve a complete degreasing of the fresh oiled panels (grading 4) is shown in Table 2 below.

TABLE 2

| | | Cleaning | Cleaning |
|---|---|---|---|
| | | time | time |
| | | (min) | (min) |
| | | for | for |
| | | MBZE** | MBZE** |
| | | with | with |
| | Ratio | fresh | fresh |
| Surfactant | PO/EO | Ferrocote | Anticorit |
| #6 | 8/7 | 2 | 3 |
| #7 | 8/5 | 5 | 3 |
| #8 | 9/5 | 5 | 2 |

**3 g/L of surfactant is used

As shown in the table, the cleaning time to get a complete degreasing of fresh oiled panels is lower than 5 min highlighting a good degreasing performance for surfactants mainly for Anticorit® PL 3802-39S.

The time required to achieve a complete degreasing of the aged oiled panels (grading 4) is shown in Table 3 below.

TABLE 3

| | | Cleaning | Cleaning | Cleaning |
|---|---|---|---|---|
| | | time | time | time |
| | | (min) | (min) | (min) |
| | | for | for | for |
| | | A16014* | MBZE** | MBZE** |
| | | with | with | with |
| | Ratio | aged | aged | aged |
| Surfactant | PO/EO | Ferrocote | Ferrocote | Anticorit |
| #6 | 8/7 | 3.2 | 3 | 1 |
| #7 | 8/5 | 3.5 | 9 | 1 |
| #8 | 9/5 | 3.4 | 7 | 1 |

*1 g/L of surfactant is used
**3 g/L of surfactant is used

Degreasing performance of surfactants is also highlighted when oils are aged (siccativation) prior to the degreasing operation. Cleaning time of A16014 panels oiled with aged Ferrocote still lower than 5 min and decreases with surfactants containing higher PO/EO ratio. 1 min of cleaning is needed to clean MBZE panels with aged Anticorit. Higher cleaning time (3-9 min) is needed for aged Ferrocote.

### Example 5

### Foam Test

The foam test is carried out at 25° C. and 55° C. (work temperature) using the hand shaking method. 100 ml of the alkaline bath described above (pH=10.5) containing 0.1% by weight of surfactant are introduced in 250 ml cylinder and with 0.3% by weight of oil (Ferrocote® 6130 or Anticorrit® PL 3802-39S). The cylinder is shacked 20 times added and the foam height is recorded at different times. The foam height results are listed in Tables 4 to 7 below.

TABLE 4
Foam height at 25° C. for bath containing
Anticorit ® PL 3802-39S

| | Ratio | 0 | 15 | 30 | 1 | 2 | 3 | 4 | 5 |
|---|---|---|---|---|---|---|---|---|---|
| Surfactant | PO/EO | S | S | S | min | min | min | min | min |
| #1 | 5/7 | 10 | 0 | 0 | 0 | 0 | 0 | 0 | 0 |
| #2 | 5/8 | 5 | 0 | 0 | 0 | 0 | 0 | 0 | 0 |
| #3 | 5/9 | 8 | 0 | 0 | 0 | 0 | 0 | 0 | 0 |
| #4 | 6/7 | 4 | 0 | 0 | 0 | 0 | 0 | 0 | 0 |
| #5 | 7/7 | 1 | 0 | 0 | 0 | 0 | 0 | 0 | 0 |
| #6 | 8/7 | 1 | 0 | 0 | 0 | 0 | 0 | 0 | 0 |
| #7 | 8/5 | 1 | 0 | 0 | 0 | 0 | 0 | 0 | 0 |
| #8 | 9/5 | 1 | 0 | 0 | 0 | 0 | 0 | 0 | 0 |

TABLE 5
Foam height at 25° C. for bath containing Ferrocote ® N6130

| | Ratio | 0 | 15 | 30 | 1 | 2 | 3 | 4 | 5 |
|---|---|---|---|---|---|---|---|---|---|
| Surfactant | PO/EO | S | S | S | min | min | min | min | min |
| #1 | 5/7 | 37 | 0 | 0 | 0 | 0 | 0 | 0 | 0 |
| #2 | 5/8 | 48 | 0 | 0 | 0 | 0 | 0 | 0 | 0 |
| #3 | 5/9 | 40 | 0 | 0 | 0 | 0 | 0 | 0 | 0 |
| #4 | 6/7 | 12 | 0 | 0 | 0 | 0 | 0 | 0 | 0 |
| #5 | 7/7 | 11 | 0 | 0 | 0 | 0 | 0 | 0 | 0 |
| #6 | 8/7 | 7 | 0 | 0 | 0 | 0 | 0 | 0 | 0 |
| #7 | 8/5 | 9 | 0 | 0 | 0 | 0 | 0 | 0 | 0 |
| #8 | 9/5 | 10 | 0 | 0 | 0 | 0 | 0 | 0 | 0 |

TABLE 6
Foam height at 55° C. for bath containing
Anticorit ® PL 3802-39S

| | Ratio | 0 | 15 | 30 | 1 | 2 | 3 | 4 | 5 |
|---|---|---|---|---|---|---|---|---|---|
| Surfactant | PO/EO | S | S | S | min | min | min | min | min |
| #1 | 5/7 | 25 | 0 | 0 | 0 | 0 | 0 | 0 | 0 |
| #2 | 5/8 | 33 | 0 | 0 | 0 | 0 | 0 | 0 | 0 |
| #3 | 5/9 | 23 | 0 | 0 | 0 | 0 | 0 | 0 | 0 |
| #4 | 6/7 | 7 | 0 | 0 | 0 | 0 | 0 | 0 | 0 |
| #5 | 7/7 | 8 | 0 | 0 | 0 | 0 | 0 | 0 | 0 |
| #6 | 8/7 | 3 | 0 | 0 | 0 | 0 | 0 | 0 | 0 |
| #7 | 8/5 | 9 | 0 | 0 | 0 | 0 | 0 | 0 | 0 |
| #8 | 9/5 | 10 | 0 | 0 | 0 | 0 | 0 | 0 | 0 |

TABLE 7
Foam height at 55° C. for bath containing Ferrocote ® 6130

| | Ratio | 0 | 15 | 30 | 1 | 2 | 3 | 4 | 5 |
|---|---|---|---|---|---|---|---|---|---|
| Surfactant | PO/EO | S | S | S | min | min | min | min | min |
| #1 | 5/7 | 37 | 0 | 0 | 0 | 0 | 0 | 0 | 0 |
| #2 | 5/8 | 47 | 0 | 0 | 0 | 0 | 0 | 0 | 0 |
| #3 | 5/9 | 40 | 0 | 0 | 0 | 0 | 0 | 0 | 0 |
| #4 | 6/7 | 10 | 0 | 0 | 0 | 0 | 0 | 0 | 0 |
| #5 | 7/7 | 9 | 0 | 0 | 0 | 0 | 0 | 0 | 0 |
| #6 | 8/7 | 8 | 0 | 0 | 0 | 0 | 0 | 0 | 0 |
| #7 | 8/5 | 7 | 0 | 0 | 0 | 0 | 0 | 0 | 0 |
| #8 | 9/5 | 8 | 0 | 0 | 0 | 0 | 0 | 0 | 0 |

The foam height decreases when PO/EO ratio increases at 25° C. and 55° C. for both Ferrocote® 6130 and Anticorit® PL 3802 39S. The surfactants #6 to #8 present a low foam behavior by hand shaking method. The foam height with Anticorit® PL 3802 39S is very low at 25° C. The foam height with Ferrocote® 6130 is similar at both temperatures.

1. A compound obtained by alkoxylation of a reaction product of a ketone and a polyol.

2. The compound of claim 1, wherein the alkoxylation is performed with two or more epoxides.

3. The compound of claim 1, wherein the polyol is a sugar or glycerol.

4. The compound of claim 1, wherein the ketone is cyclopentanone, cyclohexanone, or methyl isobutyl ketone (MIBK), preferably MIBK.

5. The compound of claim 1, wherein the compound has a formula Z—(XO)n-(EO)p-(XO)q-H, wherein:
Z is the radical deriving from the reaction product of the ketone with the polyol;
XO is PO, BO, or a mixture thereof;
n is a mean value in a range from 1 to 12;
p is a mean value in a range from 1 to 12; and
q is a mean value in a range from 0 to 12.

6. The compound of claim 5, wherein q is 0 and the reaction product is either Z—(XO)n-bloc-(EO)p-H or Z—(XO)n-stat-(EO)p-H.

7. The compound of claim 5, wherein q is different from 0 and the reaction product is either Z—(XO)n-bloc-(EO)p-bloc-(XO)q-H or Z—(XO)n-bloc-[(EO)p-stat-(XO)q]-H or Z—[(XO)n-stat-(EO)p]-bloc-(XO)q-H.

8. The compound of claim 6, wherein the compound has a formula (I) 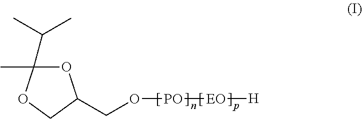
wherein the [PO]n symbol represents a polyoxypropylene block,
the [EO]p symbol represents a poyloxyethylene block.

9. The compound of claim 8, wherein a ratio of n/p is superior to 1.

10. A process for the preparation of the compound of claim 1, wherein the process comprises successively carrying out polyalkoxylation reactions with a reactant of formula (II) 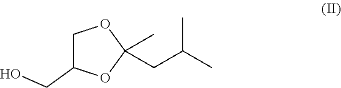
first with polypropylene oxide, then with polyethylene oxide in order to obtain the compound.

11. A method for providing a surfactant and/or defoaming agent, the process comprising:
providing the compound as defined in claim 1 as the surfactant and/or defoaming agent.

12. The method according to claim 11, wherein the surfactant and/or defoaming agent is provided in aqueous media, wherein the aqueous media is a degreasing aqueous media for degreasing metal parts, an aqueous media for-degreasing drilling platforms, an aqueous media for cleaning oil drilling wells, and an aqueous detergent media for household detergency or industrial and institutional detergency.

13. The method according to claim 11, wherein the compound is a surfactant for hard surface cleaning.

14. An aqueous formulation for degreasing metal surfaces in alkaline medium or oil drilling wells or detergents comprising the compound of claim 1.

15. The aqueous formulation of claim 14 for degreasing metal sheets in alkaline medium, wherein the compound is present in a proportion of the order of 0.01 to 5 g/l of the medium.

16. The compound of claim 1, wherein the alkoxylation is performed with two epoxides.

17. The compound of claim 1, wherein the alkoxylation is performed with ethylene oxide and propylene oxide, or ethylene oxide and butylene oxide.

18. The compound of claim 17, wherein the alkoxylation is performed with ethylene oxide and propylene oxide.

19. The compound of claim 1, wherein the polyol is glycerol.

20. The compound of claim 1, wherein the ketone is MIBK.
